(19) United States
(12) Patent Application Publication
(10) Pub. No.: US 2013/0210467 A1
(43) Pub. Date: Aug. 15, 2013

(54) APPARATUS AND METHOD FOR RECEIVING PAGING MESSAGE IN WIRELESS ACCESS SYSTEM

(71) Applicants: Jeongki Kim, Anyang-si (KR); Youngsoo Yuk, Anyang-si (KR); Giwon Park, Anyang-si (KR); Heejeong Cho, Anyang-si (KR); Kiseon Ryu, Anyang-si (KR)

(72) Inventors: Jeongki Kim, Anyang-si (KR); Youngsoo Yuk, Anyang-si (KR); Giwon Park, Anyang-si (KR); Heejeong Cho, Anyang-si (KR); Kiseon Ryu, Anyang-si (KR)

(73) Assignee: LG ELECTRONICS INC., Seoul (KR)

(21) Appl. No.: 13/880,635

(22) PCT Filed: Oct. 20, 2011
(86) PCT No.: PCT/KR2011/007836

§ 371 Date: Apr. 19, 2013

Related U.S. Application Data
(60) Provisional application No. 61/394,780, filed on Oct. 20, 2010.

(30) Foreign Application Priority Data
Oct. 19, 2011 (KR) 10-2011-0107212

(51) Int. Cl. H04W 68/02

(52) U.S. Cl. CPC H04W 68/02
USPC 455/458

(57) ABSTRACT

Disclosed is a method for receiving a paging message by a mobile station in an idle mode including an unavailable interval (UAI) and an available interval (AI) in a wireless access system, including: checking whether or not system information has been changed during the UAI; when the system information has been changed during the UAI, updating the system information during the UAI; and receiving the paging message from a base station (BS) during the AI.

### TECHNICAL FIELD

The present invention relates to a wireless access system and, more particularly, to a method and apparatus for receiving a paging message by a mobile station in an idle mode.

### BACKGROUND ART

### M2M Communication (or Machine Type Communication (MTC))

Hereinafter, M2M communication (or Machine Type communication (MTC)) will be described briefly.

M2M communication refers to communication between electronic devices as it puts it. Namely, M2M communication refers to communication between objects. In general, M2M communication refers to wired or wireless communication between electronic devices or between human-controlled devices and machines, but here, it is used to particularly designate wireless communication between electronic devices, namely, between machines or equipment. Also, M2M terminals used in a cellular network have inferior performance or capabilities to those of general terminals.

There are numerous terminals within a cell, and they may be classified according to types, classes, service types, and the like, thereof.

For example, terminals may be divided into a human type communication (HTC) and a machine type communication (MTC) according to operation types of terminals. The MTC may include communication between M2M terminals. Here, HTC refers to transmission and reception signals upon being determined by a human being, and the MTC refers to a signal transmission by each terminal according to the occurrence of an event or periodically without the intervention of a human being.

Also, when the M2M communication (or MTC) is considered, the number of entire terminals may be sharply increased. The M2M terminals may have the following characteristics according to services supported by the M2M terminals.

1. Numerous terminals within a cell

2. Small amount of data

3. Low transmission frequency (which may have periodicity)

4. Limited number of data characteristics

5. Insensitive to time delay

6. Have low mobility or fixed

M2M communication may be used in various fields such as protection access or connection and surveillance, tracking and discovery, public security (emergency, disaster), payment (vending machine, ticket machine, parking meter), healthcare, remote controlling, smart meter, and the like.

Characteristics of MTC Having Time-Controlled Traffic

Characteristics of MTC having time-controlled traffic is aimed to be used in an MTC application defined to transmit or receive data only during a defined time interval and avoid unnecessary signaling in other time intervals than then defined time interval. A network operator may allocate resources differently over traffic generation to thus allow the MTC applications to transmit or receive data or perform signaling in other time intervals than the defined time interval.

The defined connection period (e.g., 10 minutes) is previously agreed between the network operator and an MTC terminal (subscriber), which is sufficiently long to guarantee a completion of normal communication between the MTC terminal and an MTC server.

When communication with the MTC server is finished, the MTC terminal does not need to wait until when the connection period expires, to release its connection to the MTC server.

In general, an MTC user agrees with the operator on a predetermined time interval with respect to one MTC terminal group. A time during which a connection is allowed is called a ‘grant time interval’, and a time during which a connection is not allowed (or forbidden) is called a ‘forbidden time interval’. Also, a time during which communication is substantially performed in the grant time interval is called a ‘communication window’.

A network can communicate with the MTC terminal during the grant time interval and also communicate with the MTC user and the MTC server during the grant time interval. The ‘grant time interval’ does not overlap with the ‘forbidden time interval’ during which a connection is forbidden.

In general, a communication window of 5 to 10 minutes is sufficient for each MTC terminal. The network operator may limit the interval of the communication window. In order to avoid a network overload, signaling and data traffic of MTC terminals in the communication window are distributed by the predetermined time interval (e.g., by randomizing a start time of each communication window.

### DISCLOSURE OF INVENTION

### Technical Problem

As described above, a paging cycle of an M2M terminal having features of time-controlled traffic based on a specific interval and features of a long term schedule is highly likely to have a long paging cycle based on the corresponding interval in order to effectively save power of the M2M terminal.

In the case of an HTC terminal, if it fails to receive changed system information through a superframe header (SFH) or a broadcast message before receiving a paging message in an idle mode from a base station or a paging controller, the HTC terminal may miss (or lose) the paging message. In this case, the HTC terminal may update the changed system information and then receive the paging message during a next paging interval.

In the case of an M2M terminal, if it fails to receive a paging message during a corresponding paging interval, it should wait for a next paging interval in order to receive the paging message.

However, in the case of M2M terminal, paging cycle is lengthy and when DL traffic to be transmitted to the M2M terminal is generated during a corresponding paging interval, the DL traffic of the M2M terminal is delayed until the next paging interval.

Therefore, an object of the present invention is to provide a method for solving a problem in which an M2M terminal fails to receive a paging message in an idle mode.

### Solution to Problem

According to an aspect of the present invention, there is provided a method for receiving a paging message by a mobile station in an idle mode including an unavailable interval (UAI) and an available interval (AI) in a wireless access system, including: checking whether or not system information has been changed during the UAI; when the system information has been changed during the UAI, updating the system information during the UAI; and receiving the paging message from a base station (BS) during the AI.

The checking of whether or not the system information has been changed may include: waking up at a particular point in time during the AI; and receiving control information indicating whether or not the system information has been changed from the BS.

In the updating of the system information, a superframe header (SFH) including updated system information may be received from the BS.

The superframe header may further include an SFH change cycle.

The particular point in time may be a superframe number at which the result of a modulo operation of a superframe number and the superframe header change cycle is 0.

The method may further include: comparing a length from the particular point in time until to a point in time at which the AI starts with a transmission cycle of the SFH; and when the length from the particular point in time to the point in time at which the AI starts is shorter than the transmission cycle of the SFH, waking up at a corresponding superframe number ahead of the superframe header change cycle starting from the particular point in time.

The particular point in time may be a superframe number at which the result of a modulo operation of a superframe number and the superframe header change cycle is 0, and may be a superframe number closest to the AI.

The control information may be secondary superframe header (S-SFH) change count.

The control information may be received through a primary superframe header information element (P-SFH IE).

The method may further include: re-checking whether or not the system information has been changed at the particular point in time; and when the system information has not been changed, changing into a power saving mode.

According to another aspect of the present invention, there is provided a method for receiving a paging message by a mobile station in an idle mode in a wireless access system, including: receiving a control message including a first paging cycle and a second paging cycle shorter than the first paging cycle, the first and second paging cycles being comprised of an unavailable interval (UAI) and an available interval (AI), respectively; and receiving the paging message from the BS during the AI, wherein when the paging message is not received from the BS during the AI of the first paging cycle, the second paging cycle is applied.

The control message may further include paging offset information indicating a start timing of the AI with respect to each of the first and second paging cycles, or a paging listening interval indicating the length of AI of each of the first and second paging cycles.

The control message may further include control information indicating the number of applications of the second paging cycle.

The method may further include: repeatedly applying the second paging cycle according to the control information.

The method may further include: perform a network re(entry) process with the BS.

The method may further include: transmitting a paging confirmation request message in order to check whether or not a paging message has been transmitted to the BS, when the paging message has not been received during the AI of the second paging cycle from the BS; and receiving a response with respect to the paging confirmation request message from the BS.

The method may further include: when the response with respect to the paging confirmation request message is a positive response, performing the network (re)entry process with the BS.

The control message may be a deregistration request (DREG-REQ) message or a deregistration response (DREG-RSP) message.

According to another aspect of the present invention, there is provided a mobile station for receiving a paging message in an idle mode including an unavailable interval (UAI) and an available interval (AI) in a wireless access system, including: a wireless communication unit for transmitting and receiving a radio frequency (RF) signal to and from the outside; and a controller connected with the wireless communication unit, wherein the controller checks whether or not system information has been changed during the UAI, and when the system information has been changed according to the checking results, the controller updates the system information during the UAI, and controls the wireless communication unit to receive the paging message from the BS during the AI based on the updated system information.

The controller may control the mobile station to wake up at a particular point in time during the UAI, and control the wireless communication unit to receive control information indicating whether or not the system information has been changed from the BS, thus confirming whether or not the system information has been changed.

The controller may control the wireless communication unit to receive a superframe header (SFH) including the updated system information from the BS.

The SFH may further include an SFH change cycle.

The particular point in time may be a superframe number at which the result of a modulo operation of a superframe number and the superframe header change cycle is 0.

The controller may compare a length from the particular point in time to a point in time at which the AI starts with a transmission cycle of the SFH, and when the length from the particular point in time to the point in time at which the AI starts is shorter than the transmission cycle of the SFH, the controller may awake the mobile station at a corresponding superframe number ahead of the superframe header change cycle starting from the particular point in time.

The particular point in time may be a superframe number at which the result of a modulo operation of a superframe number and the superframe header change cycle is 0, and may be a superframe number closest to the AI.

The controller may re-check whether or not the system information has been changed at the particular point in time, and when the system information has not been changed, the controller may control the mobile station to be changed into a power saving mode.

According to another aspect of the present invention, there is provided a mobile station for receiving a paging message in an idle mode in a wireless access system, including: a wireless communication unit for transmitting and receiving a radio frequency (RF) signal to and from the outside; and a controller connected with the wireless communication unit, wherein the controller controls the wireless communication unit to receive a control message including a first paging cycle and a second paging cycle shorter than the first paging cycle from a base station, each of the first and second paging cycles is comprised of an unavailable interval (UAI) and an available interval (AI), and the controller controls the wireless communication unit to receive the paging message from the BS during the AI, and when the paging message is not received from the BS during the AI of the first paging cycle, the controller controls the mobile station to apply the second paging cycle.

### Advantageous Effects of Invention

According to embodiments of the present invention, since the changed system information is updated during an UAI of the idle mode in advance, the problem in which the M2M MS fails to receive a paging message during an AI can be solved, thus preventing delay of DL traffic.

Also, since a plurality of different paging cycles are allocated to the M2M MS, if a paging message is not received during a longer paging cycle, a shorter paging cycle can be applied, thus preventing delay of DL traffic and power consumption of the M2M MS.

### BRIEF DESCRIPTION OF DRAWINGS

FIG. 1 is a view showing a paging procedure in an idle mode.

FIG. 2 is a conceptual view of a wireless communication system to which an embodiment of the present disclosure can be applicable.

FIG. 3 is a flow chart illustrating the process of a method for receiving a paging message according to a first embodiment of the present disclosure.

FIG. 4 is a view showing a process of updating system information during an unavailable interval of an idle mode according to a first embodiment of the present disclosure.

FIG. 5 is a view showing another process of updating system information during an unavailable interval in an idle mode according to a first embodiment of the present disclosure.

FIG. 6 is a flow chart illustrating the process of a method for receiving a paging message by an M2M mobile station (MS) according to a second embodiment of the present disclosure.

FIG. 7 is a flow chart illustrating the process of a method for receiving a paging message in the idle mode according to the second embodiment of the present disclosure.

FIG. 8 is a flow chart illustrating the process of another method for receiving a paging message in the idle mode according to the second embodiment of the present disclosure.

FIG. 9 is a flow chart illustrating the process of another method for receiving a paging message in the idle mode according to the second embodiment of the present disclosure.

FIG. 10 is a schematic block diagram of a mobile station and a base station in a wireless access system to which an embodiment of the present disclosure can be applicable.

### MODE FOR THE INVENTION

The following technique may be used for various wireless communication systems such as CDMA (code division multiple access), FDMA (frequency division multiple access), TDMA (time division multiple access), OFDMA (orthogonal frequency division multiple access), SC-FDMA (single carrier-frequency division multiple access), and the like. CDMA may be implemented as a radio technology such as UTRA (Universal Terrestrial Radio Access) or CDMA2000. TDMA may be implemented as a radio technology such as GSM (Global System for Mobile communications)/GPRS (General Packet Radio Service)/EDGE (Enhanced Data Rates for GSM Evolution). OFDMA may be implemented as a radio technology such as IEEE 802.11 (Wi-Fi), IEEE 802.16 (WiMAX), IEEE 802-20, E-UTRA (Evolved UTRA), and the like. IEEE 802.16m is an advancement of IEEE 802.16e, providing backward compatibility with an IEEE 802.16e-based system.

Also, 802.16p provides a communication standard for supporting machine type communication (MTC).

UTRA is a part of UMTS (Universal Mobile Telecommunications System). 3GPP (3rd Generation Partnership Project) LTE (long term evolution) is part of E-UMTS (Evolved UMTS) using E-UTRA, which employs OFDMA in downlink and SCFDMA in uplink. LTE-A (Advanced) is an advancement of 3GPP LTE.

The terminology used herein is for the purpose of describing particular embodiments only and is not intended to be limiting of the invention. Unless otherwise defined, all terms used herein have the same meaning as commonly understood by one of ordinary skill in the art to which this invention pertains, and should not be interpreted as having an excessively comprehensive meaning nor as having an excessively contracted meaning. If technical terms used herein is erroneous that fails to accurately express the technical idea of the present invention, it should be replaced with technical terms that allow the person in the art to properly understand. The general terms used herein should be interpreted according to the definitions in the dictionary or in the context and should not be interpreted as an excessively contracted meaning.

In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

While terms such as “first” and “second,” etc., may be used to describe various components, such components must not be understood as being limited to the above terms. The above terms are used only to distinguish one component from another. For example, a first component may be referred to as a second component without departing from the scope of rights of the present invention, and likewise a second component may be referred to as a first component. The term “and/or” encompasses both combinations of the plurality of related items disclosed and any item from among the plurality of related items disclosed.

When a component is mentioned as being “connected” to or “accessing” another component, this may mean that it is directly connected to or accessing the other component, but it is to be understood that another component may exist therebetween. On the other hand, when a component is mentioned as being “directly connected” to or “directly accessing” another component, it is to be understood that there are no other components in-between.

The exemplary embodiments of the present invention will now be described with reference to the accompanying drawings, in which like numbers refer to like elements throughout. In describing the present invention, if a detailed explanation for a related known function or construction is considered to unnecessarily divert the gist of the present invention, such explanation has been omitted but would be understood by those skilled in the art. The accompanying drawings of the present invention aim to facilitate understanding of the present invention and should not be construed as limited to the accompanying drawings. The technical idea of the present invention should be interpreted to embrace all such alterations, modifications, and variations in addition to the accompanying drawings.

Paging in Idle Mode

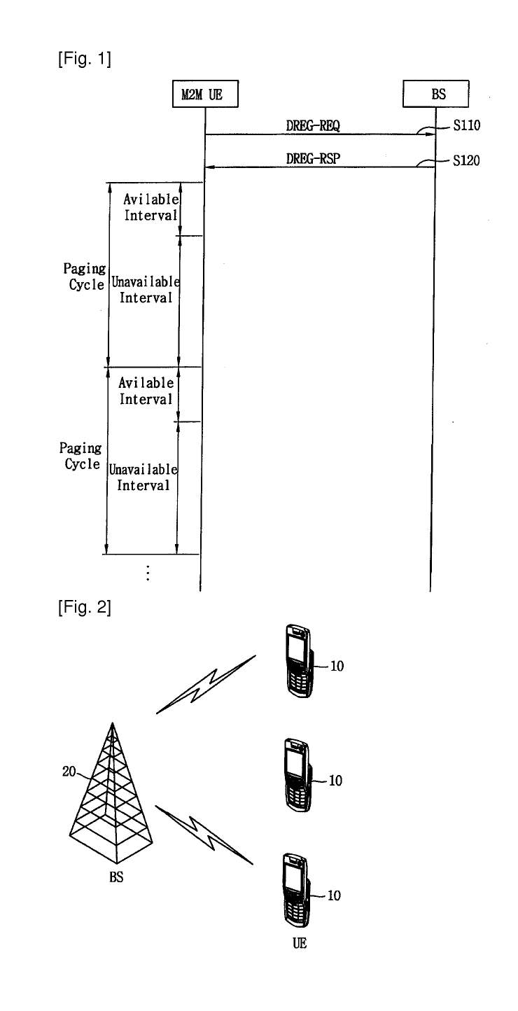

FIG. 1 is a view showing a paging procedure in an idle mode.

With reference to FIG. 1, in order to enter an idle mode, a mobile station (MS) transmits a deregistration request (DREG-REQ) message to a base station (BS) in order to request deregistration with the BS.

Then, in response to the DREG-REQ message, the BS transmits a deregistration response (DREG-RSP) message to the MS (S120). Here, the DREG-RSP message includes paging information.

Here, MS's entering the idle mode may also be initiated by a request from the BS. In this case, the BS transmits the DREG-RSP message to the MS.

The paging information may include a paging cycle, a paging offset, a paging group identifier (PGID), a paging listening interval value, and the like.

When the MS receives the DREG-RSP, it enters an idle mode with reference to the paging information.

The idle mode has paging cycles, and one paging cycle may include an available interval and an unavailable interval. Here, the available interval is the same concept as a paging listening interval and a paging interval. The paging offset indicates a point in time (e.g., a frame or a subframe) at which a paging interval in a paging cycle starts. The paging group identifier (PGID) is an identifier (ID) of a paging group allocated to an MS.

The paging information may include paging message offset information. Here, the paging message offset information indicates a point in time at which a paging message is transmitted from the BS.

Thereafter, the MS may receive a paging message transmitted to the MS itself during the AI (namely, the paging listening interval) by using the paging information. Here, the paging message may be transmitted through the BS or a paging controller.

S-SFH SP (Secondary SuperFrameHeader SubPacket Information Element) updating

Hereinafter, a method for updating S-SFH SP (Secondary SuperFrameHeader SubPacket Information Element) will now be described briefly.

First, the SFH is comprised of a primary SFH and a secondary SFH, and includes system information.

The S-SFH is comprised of three subpackets S-SFH SP1, S-SFH SP2, and S-SFH SP3, and the three subpackets have different cycles and are transmitted at different points in time.

Table 1 below shows an example of a P-SFH IE format and Table 2 below shows an example of an S-SFH SP3 IE format.

TABLE 1

| Syntax | Size(bit) | Notes |
|---|---|---|
| P-SFH IE format( ){ | | |
| LSB of superframe number | 4 | Part of superframe number |
| S-SFH change count | 4 | Indicates the value of S-SFH |
| | | change conunt associated with |
| | | the S-SFH SPx IE(s) transmitted |
| | | in this S-SFH change cycle |
| S-SFH size extension | 2 | 0b00:Size_{SPx, extension} = 00b01: |
| | | Size_{SPx, extension} = 80b02: |
| | | Size_{SPx, extension} = 160b03: |
| | | Size_{SPx, extension} = 24 |
| Number of repetitions for | 2 | Indicates the number of |
| S-SFH(N_{Rep, S-SFH}) | | repetitions used for S-SFH |
| | | transmission0b00:reserved0b01: |
| | | 60b10:30b11:1 |
| S-SFH scheduling | 2 | Indicates which S-SFH SP |
| information | | IE is included in S-SFH at |
| | | this superframe0b00:S-SFH |
| | | SP1 IE0b01:S-SFH SP2 |
| | | IE0b10:S-SFH SP3 |
| | | IE0b11:no S-SFH |
| S-SFH SP change bitmap | 3 | Indicates the change in the |
| | | content of S-SFH SPx IE(s) |
| | | between current SFH and |
| | | previous SFH associated |
| | | with the S-SFH change |
| | | count. If bit#0(LSB) = 1, |
| | | change in S-SFH SP1 IE. |
| | | Otherwise no change in SP1 |
| | | IE. If bit#1 = 1, change in S- |
| | | SFH SP2 IE. Otherwise no |
| | | change in SP2 IE. If |
| | | nit#2(MSB) = 1, change in |
| | | S-SFH SP3 IE. Otherwise |
| | | no change in SP3 IE. |
| S-SFH application hold | 1 | Indicates the S-SFH change |
| indicator | | count value used to |
| | | determine the S-SFH SPx |
| | | IE content to apply in this |
| | | superframe. 0b0:Use S-SFH |
| | | SPx IE content associated |
| | | with the current S-SFH |
| | | change count0b1:Use S- |
| | | SFH SPx IE content associated |
| | | with(the current S-SFH |
| | | change count-1) modulo 16 |
| Reserved | 3 | The reserved bits are for |
| | | future extension. |

TABLE 2

| Syntax | Size(bit) | Notes |
|---|---|---|
| S-SFH SP3 IE format( ){ | | |
| S-SFH change cycle | 3 | It is the minimum |
| | | duration (unit:superframe) |
| | | over which the contents of |
| | | the S-SFH remain the same. |
| | | 0b000:160b001:320b010: |
| | | 640b011~0b111:reserved |
| SA-Preamble sequence soft | 4 | Specifies the partition |
| partitioning information | | information of SA-Preamble |
| | | sequence for non-macro |
| | | ABS as public and CSG |
| | | femto BS. |

The MS receives a P-SFH IE, (primary superframe header information element) and checks an S-SFH change count field. Whenever the S-SFH IE, information is updated, the BS increases the value of the S-SFH change count field by 1 each time.

When the S-SFH change count field value is different from that of the MS, the MS determines that the S-SFH SP IE has been updated, and checks an S-SFH SP change bit map of the P-SFH IE to check which S-SFH SP has been updated.

The MS checks the S-SFH Scheduling information bitmap in the P-SFH IE to check which S-SFH SP IE is transmitted in the current SFH. When an S-SFH SP IE to be updated is updated in the current SFH, the MS checks the corresponding S-SFH SP IE and updates it.

When the S-SFH SP IE to be updated is not transmitted in the current SFH, the MS receives the S-SFH SP IE during a next period in which the S-SFH SP IE to be updated is transmitted, and updates it.

When the MS receives the S-SFH SP IE to be updated, the MS first checks a start superframe offset where new SP information is used. And then, the MS updates the SSFH SP IE at the superframe position corresponding to the start superframe offset.

FIG. 2 is a conceptual view of a wireless communication system to which an embodiment of the present disclosure can be applicable. The wireless communication system is widely disposed to provide various communication services such as voice, packet data, or the like.

With reference to FIG. 2, the wireless communication system may include a mobile station (MS) 10 and a base station (BS) 20. The MS may be fixed or mobile and may be called by other names such as UE (User Equipment), UT (User Terminal), SS (Subscriber S [symbol] tation), wireless device), AMS (Advanced Mobile Station), or the like. Also, the MS 10 may have a concept of MTC or M2M terminal.

The BS 20 generally refers to a fixed station communicating with the MS 10, and may be called by other names such as NodeB, BTS (Base Transceiver System), access point. One or more cells may exist in the single BS 20.

The wireless communication system may be an OFDM (Orthogonal Frequency Division Multiplexing)/OFDMA (Orthogonal Frequency Division Multiple Access)-based system.

OFDM uses multiple orthogonal subcarriers. OFDM uses orthogonal characteristics between IFFT (inverse fast Fourier Transform) and FFT (fast Fourier Transform). A transmitter performs IFFT on data and transmits the same. A receiver performs FFT on received signal to restore the original data. The transmitter uses IFFT in order to couple multiple subcarriers, and the receiver uses corresponding FFT in order to separate multiple subcarriers.

Respective embodiments of methods for receiving a paging message in an idle mode by MSM MSs (or MTC MSs) proposed in the present invention will now be described.

### First Embodiment

A first embodiment of the present invention provides a method for receiving a paging by updating system information during an AI of an idle mode by an M2M MS.

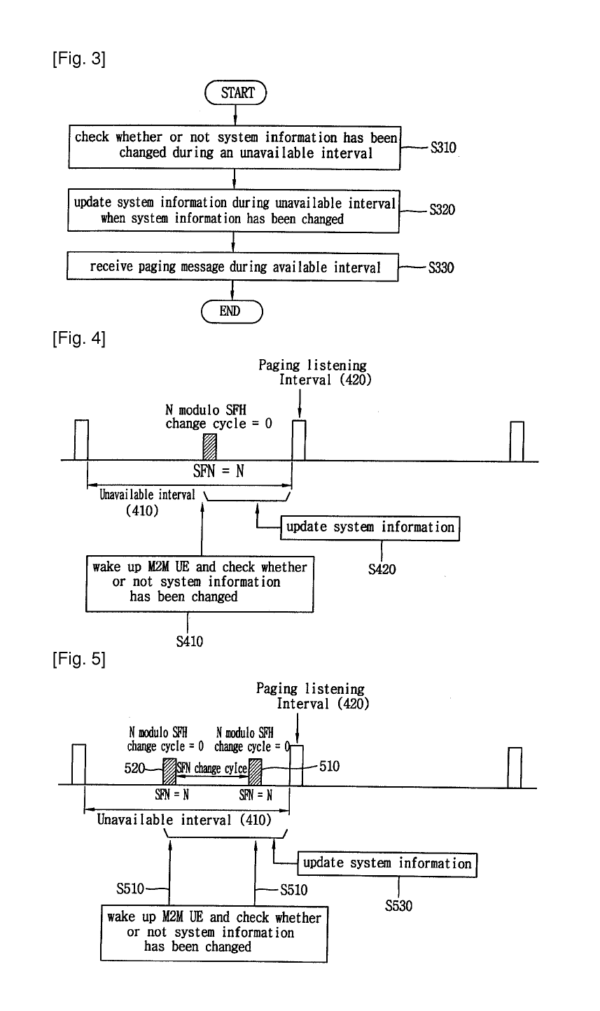

FIG. 3 is a flow chart illustrating the process of a method for receiving a paging message according to a first embodiment of the present disclosure.

With reference to FIG. 3, the M2M MS checks whether or not system information transmitted through an SFH during an UAI in a paging cycle has been changed (S310).

Here, in order to check whether or not the system information has been changed, the M2M MS wakes up at a particular point in time during the UAI and receives control information (e.g., S-SFH change count) indicating whether or not the system information has been changed, from the BS.

The control information is transmitted through a P-SFH IE.

The processing of checking whether or not the system information has been changed at a particular point during the UIA and updating the system information will be described in detail with reference to FIGS. 4 and 5.

Thereafter, when the M2M MS determines that the system information has been changed, the M2M MS updates the system information during the UIA (S320). Here, the processing of updating the system information is performed upon receiving updated system information from the BS, and the updated system information is transmitted from the BS through an SFH, in particular, S-SFH.

Thereafter, the M2M MS receives a paging message from the BS (or a paging controller) during the AI in the paging cycle (S330).

And then, when the received paging message is a message that pages the M2M MS itself, the M2M MS performs a network re-entry process with the BS.

FIG. 4 is a view showing a process of updating system information during an unavailable interval of an idle mode according to a first embodiment of the present disclosure.

As shown in FIG. 4, the M2M MS wakes up before the AI or the paging listening interval 420, namely, at a particular point in time during the UAI 410, to check whether or not the system information transferred through the SFH has been changed (S410).

Upon checking, when the system information has been changed, the M2M MS updates the system information before the paging listening interval (S420) and receives a paging message from the BS or the paging controller during the paging listening interval.

Here, the particular point in time during the UAI is a superframe number at which a modulo operation result of the superframe number and SFH change cycle is 0. Namely, the M2M MS wakes up at a superframe number immediately before a paging listening interval among superframe numbers satisfying SFN modulo SFH change cycle=0.

As discussed above, the SFH change cycle is transmitted through the S-SFH SP3 or a neighbor advertisement (NBR-ADV) message.

FIG. 5 is a view showing another process of updating system information during an unavailable interval in an idle mode according to a first embodiment of the present disclosure.

First, it is assumed that changed system information is S-SFH SP3 IE.

If the length from a particular point in time during (or within) the UAI 410 at which the M2M MS wakes up (i.e., the final superframe number (SFN) satisfying SFN modulo SFH change cycle=0 before the paging listening interval 420) to the paging listening interval 420 is shorter than the transmission cycle of the changed S-SFH SP3 IE, the M2M MS may not be able to update the changed system information during the UAI.

Thus, in such a case, as shown in FIG. 5, the M2M MS first wakes up at a superframe number 520 before the SFH change cycle rather than at the superframe number 510 corresponding to SFN modulo SFH change cycle=0 closest to the paging listening interval 420, to check whether or not the system information has been changed (S510).

Upon checking, when the system information has been changed, the MWM MS updates the system information stored in the M2M MS (S530). Similarly, the process of updating the system information by the M2M MS is performed upon receiving the changed system information from the BS.

Thereafter, the M2M MS checks whether or not the system information has been changed at the superframe number 510 after the SFN change cycle starting from the superframe number 520 (S520).

Upon checking, when the system information has not been changed, the M2M MS may be changed into a power saving mode (or power down) during the remaining UAI.

### Second Embodiment

The second embodiment provides a method for receiving a paging message by the M2M MS in an idle mode by allocating multiple (or a plurality of) paging cycles to the M2M MS by the BS.

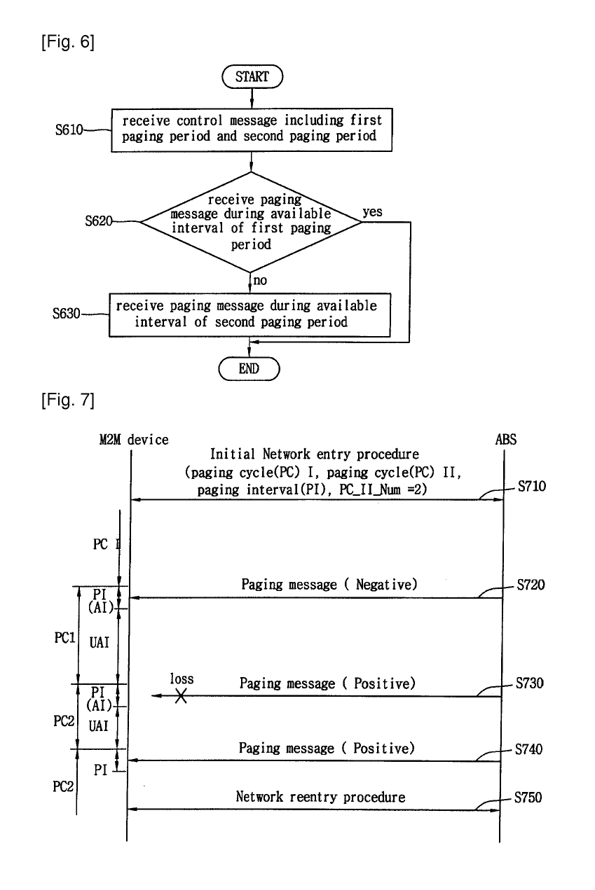

FIG. 6 is a flow chart illustrating the process of a method for receiving a paging message by an M2M terminal according to a second embodiment of the present disclosure.

With reference to FIG. 6, the M2M MS receives a control message including first and second paging cycles (S610). Here, the second paging cycle is shorter than the first paging cycle.

Also, the first and second paging cycles are comprised of a UAI and an AI, respectively, the AI may be expressed as a paging interval or a paging listening interval.

The control message may be received through an initial network entry process (RNG-REQ/RSP or REG-REQ/RSP) or may be received through an idle mode entry process, i.e., a deregistration process (DREG-REQ/RSP) between the M2M MS and the BS. For example, the control message may be a ranging request (RNG-REQ) message, a ranging response (RNG-RSP) message, a registration request (REG-REQ) message, a registration response (REG-RSP) message, a deregistration request (DREG-REQ) message, or a deregistration response (DREG-RSP) message.

Also, the control message may further include at least one of paging offset information indicating a starting point in time of the AI with respect to each of the first and second paging cycles, paging listening interval information indicating the length of an AI of each of the first and second paging cycles, and control information indicating the number of applications of the second paging cycle.

Thereafter, when the M2M MS enters the idle mode, it first applies the first paging cycle. Namely, the M2M MS performs monitoring to receive a paging message from the BS during the AI of the first paging cycle (S620).

When the M2M MS receives a paging message during the AI of the first paging cycle and the received paging message corresponds to paging the M2M MS itself, the M2M terminal performs a network reentry procedure with the BS.

If, however, the M2M MS fails to receive a paging message during the AI of the first paging cycle, the second paging cycle is applied.

Namely, the M2M MS performs monitoring to receive a paging message during the AI of the second paging cycle.

Thereafter, the M2M MS receives the paging message from the BS (S630), and when it the M2M MS confirms that it relates to its paging, the M2M MS performs a network re-entry procedure with BS.

Here, the M2M MS may repeatedly apply the second paging cycle, after the first paging cycle, according to the control information, namely, by the number of applications of the second paging cycle.

If the M2M MS fails to receive the paging message from the BS during the first and second paging cycles (including the repeated applications), the M2M MS may transmit a message for checking whether or not the paging message has been transmitted, to the BS.

The process of checking whether or not the paging message has been transmitted, to the BS when the M2M MS repeatedly applies the second paging cycle will be described in detail with reference to FIGS. 7 to 9.

FIG. 7 is a flow chart illustrating the process of a method for receiving a paging message in the idle mode according to the second embodiment of the present disclosure.

With reference to FIG. 7, the BS allocates a paging cycle (PC) 1, a PC 2, a paging interval PI, and control information (PC 2_Num=2) indicating repeated application of the paging cycle twice, to the M2M MS through an initial network entry process (S710). Here, the PC 2 has a shorter paging cycle than that of the PC 1.

As shown in FIG. 7, the paging information allocated to the M2M MS may be transferred to the M2M MS through the initial network entry process or through deregistration MAC messages (e.g., AAI-DREG-REQ/RSP) used in the processing of entering an idle mode.

In another example, the BS may allocate two paging offsets, instead of two paging cycles, to the M2M MS.

Namely, the PC_2_Num is a value indicating how many times the paging cycle 2 should be applied to receive a paging message when the M2M MS fails to receive the paging message during the paging interval of the paging cycle 1.

When the M2M MS fails to receive the paging message during the first paging listening interval of the PC 1, the M2M MS applies the PC 2 and waits indicating how many times the paging cycle 2 should be applied to receive a paging message when the M2M MS fails to receive the paging message during the paging interval of the paging cycle 1.

When the M2M MS fails to receive the paging message during the first paging listening interval of the PC 1, the M2M MS applies the PC 2 and waits to receive the paging message again from the BS.

Here, after transmitting the paging message, if there is no response (e.g., a network entry/reentry) from the M2M MS within a predetermined period even after the paging listening interval of the long paging cycle (PC) 1, the BS determines that the corresponding M2M MS has failed to receive the paging message.

Then, the BS may transmit the paging message again to the M2M MS during the paging listening interval of the short paging cycle (PC) 2.

This process is performed by a predetermined number of times (e.g., 2 to 4 times) between the BS and the M2M MS until when the corresponding M2M MS can properly receive the paging message.

As shown in FIG. 7, since PC_2_Num is 2, if the M2M MS fails to receive the paging message from the BS at the PC 1 (S720), the M2M MS further applies the paging cycle 2 twice to receive the paging message.

With respect to a positive paging message transmission (paging for waking up the M2M MS), the BS fails to receive a positive response (e.g., a network reentry or location update) from the corresponding M2M MS, the BS may further apply the paging cycle 2 until when it receives the positive response from the M2M MS.

Here, the BS transmits the paging message to the M2M MS during a predetermined paging interval of the PC2.

As shown in FIG. 7, the M2M MS fails to receive the paging message from the BS at the PC1 and during the first paging interval of the PC2 (S720, S730), and receives the paging message from the BS during the second paging interval (S740).

Namely, since the M2M MS receives a paging message for awaking the corresponding M2M MS during the second paging interval of the PC 2, the corresponding M2M MS performs a network reentry procedure (S750).

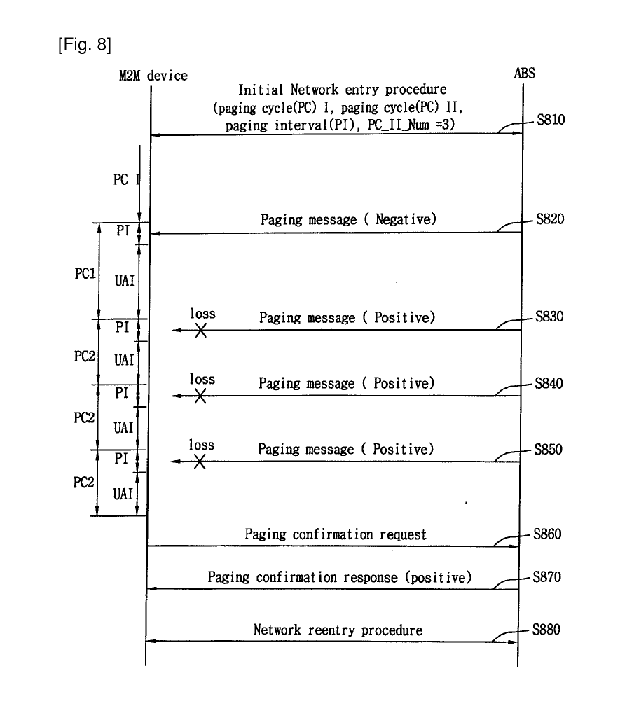

FIG. 8 is a flow chart illustrating the process of another method for receiving a paging message in the idle mode according to the second embodiment of the present disclosure.

With reference to FIG. 8, the BS transmits paging information including paging cycle 1, paging cycle 2, paging interval, and PC_2_Num=3 (S810).

Thereafter, when the M2M MS fails to receive the paging message from the BS for the predetermined number of times (three times) of the PC 1 and PC 2 (S820 to S850), the M2M MS transmits a paging confirmation request to the BS (or the paging controller) in order to confirm whether or not positive paging message has been transmitted during the paging interval of the paging cycle (S860).

Thereafter, the BS transmits a message indicating whether or not it has transmitted the positive paging message in response to the paging conformation request. In FIG. 8, the BS transmits a positive response with respect to the positive paging to the M2M MS (S870).

Thereafter, the M2M MS and the BS perform re-entry process (S880).

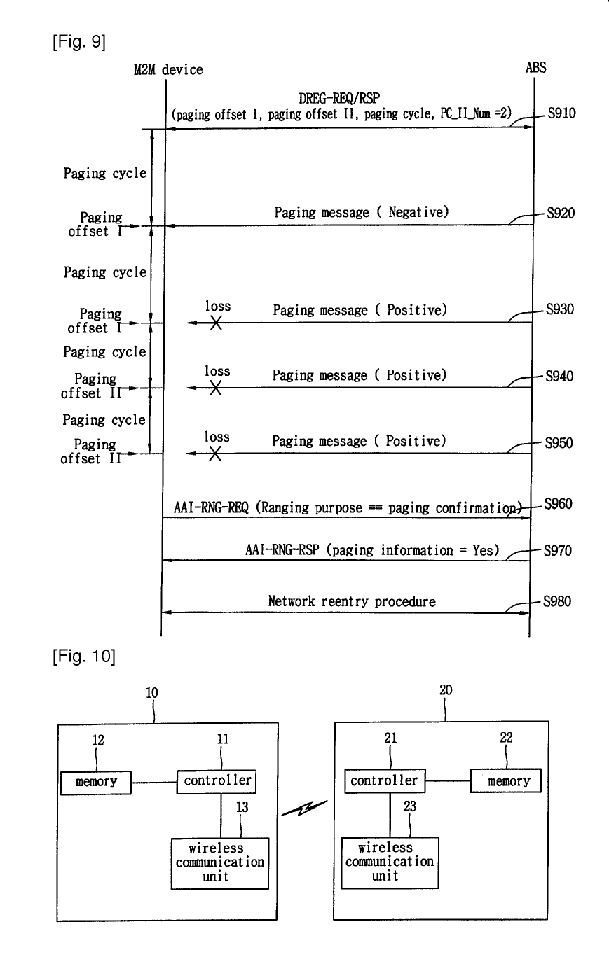

FIG. 9 is a flow chart illustrating the process of another method for receiving a paging message in the idle mode according to the second embodiment of the present disclosure.

With reference to FIG. 9, the BS allocates paging information including paging offset 1, paging offset 2, paging cycle, and PC 2_Num=2 to the M2M MS through an idle mode entry process, namely, through a deregistration process (S910).

Here, paging offset indicates a point in time at which a paging message is transmitted from the BS.

As shown in FIG. 9, when the M2M MS fails to receive the paging message at the paging offset 1 (S920, S930), the M2M MS waits for the paging message at the paging offset 2. In this case, the M2M MS may repeatedly perform the process of waiting for the paging message at the paging offset 2 by a designated number of times (PC 2_Num=2).

When the M2M MS fails to receive the paging message from the BS even after the paging offset 2 of two times (S940, S950), the M2M MS transmits a paging confirmation request to the BS (S960).

The BS transmits a paging confirmation response to the M2M MS in response to the paging confirmation request (S970).

In this case, the BS includes whether or not the paging is positive or negative in the response and provides the same to the M2M MS.

When the paging confirmation response indicates positive paging, the M2M MS performs network reentry process with the BS (S980).

Here, the paging confirmation request message and the response message are messages transmitted in the idle mode of the M2M MS, so an AAI-RNG-REQ message and an AAI-RNG-RSP message used in a ranging process may be used.

Namely, when the M2M MS determines that it has failed to receive the paging message at a designated point in time, the M2M MS may transmit the AAI-RNG-REQ after a ranging process to inform the BS or the paging controller that it has failed to receive a paging message.

Thereafter, the BS or the paging controller may transmit the AAI-RNG-RSP message to the M2M MS to inform the M2M MS of the presence of DL data.

To this end, the M2M MS may include a paging confirmation request code (which defines, for example, a new ranging purpose indication) in the AAI-RNG-REQ message and transmits the AAI-RNG-REQ message to the BS.

When the ranging purpose indication indicates the paging confirmation request, the BS includes whether or not the DL data exists in the AAI-RNG-RSP message and transmits the same to the M2M MS.

The above-described embodiments and modification examples may be combined with one another. Accordingly, each embodiment may not be implemented as a single but implemented in combination with one another when the need arises. Such combinations can be easily implemented by those skilled in the art reading this specification and the combinations thereof will not be described below in detail. However, even if not described, it should be understood that the combinations thereof will not be excluded from the present invention, and still fall within the scope of the present invention.

The foregoing embodiments and modification examples may be implemented through various means. For example, the embodiments of the present disclosure may be implemented by hardware, firmware, software, or any combination thereof.

In case of a hardware implementation, a method according to the embodiments of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In case of a firmware or software implementation, a method according to the embodiments of the present disclosure may be implemented in the form of a module, procedure, function, or the like, which performs the functions or operations as described above. The software codes may be stored in a memory unit to be driven by a processor. The memory unit may be located at an inner or outer portion of the processor to send and/or receive data to and/or from the processor by various publiclyknown means.

For example, the method according to the present invention as described above may be implemented by software, hardware, or a combination of both. For example, the method according to the present invention may be stored in a storage medium (for example, internal memory, flash memory, hard disk, and so on), and may be implemented through codes or instructions in a software program that can be performed by a processor (for example, internal microprocessor). It will be described with reference to FIG. 13.

FIG. 10 is an interval block diagram illustrating a mobile station and a base station in a wireless access system to which an embodiment of the present disclosure is applicable.

A mobile station 10 may include a controller 11, a memory 12, and a radio frequency (RF) unit 13.

Furthermore, the mobile station may also include a display unit, a user interface unit, and the like.

The controller 11 implements the proposed functions, processes and/or methods. The layers of the radio interface protocol may be implemented by the controller 11.

The memory 12, which is connected to the controller 11, may store protocols or parameters for performing wireless communication. In other words, the memory 12 may store mobile station driving systems, applications, and general files.

The RF unit 13, which is connected to the controller 11, may transmit and receive radio signals.

In addition, the display unit may display various types of information of the mobile station, and well-known elements such as a liquid crystal display (LCD), organic light emitting diodes (OLED), or the like may be used. The user interface unit may be implemented in combination of well-known user interfaces such as a keypad, a touch screen, or the like.

A base station 20 may include a controller 21, a memory 22, and a radio frequency (RF) unit 23.

The controller 21 implements the proposed functions, processes and/or methods. The layers of the radio interface protocol may be implemented by the controller 21.

The memory 22, which is connected to the controller 21, may store protocols or parameters for performing wireless communication.

The RF unit 23, which is connected to the controller 21, may transmit and receive radio signals.

The controllers 11 and 21 may include application-specific integrated circuits (ASICs), other chip sets, logic circuit and/or data processing devices, respectively. The memories 12 and 22 may include read-only memory (ROM), random access memory (RAM), flash memory, memory card, storage medium and/or other storage devices. The RF units 13 and 23 may include a baseband circuit for processing radio signals, respectively. When the embodiment is implemented by software, the foregoing technique may be implemented by a module (process, function, etc.) performing the foregoing function. The module may be stored in the memories 12 and 22, and implemented by the controllers 11 and 21.

The memories 12 and 22 may be located within or outside the controllers 11 and 21, respectively, and may be connected to the controllers 11 and 21 through well-known various means, respectively.

1. A method for receiving a paging message by a machine-to-machine(M2M) device at an idle mode in a wireless access system, the method comprising:
receiving information including a first and a second paging offsets from a base station(BS);
receiving a paging message during a first listening interval according to the first paging offset; and
receiving the paging message during a second listening interval according to the second paging offset, when the reception of the paging message during the first listening interval is failed
wherein the second paging offset is indicated in a deregistration response (DREG-RSP) message.

2. The method of claim 1, wherein the paging message includes information for performing network entry to the base station.

3. The method of claim 1, further comprising:
performing network entry with the BS, when the reception of the paging message is succeed.

4. The method of claim 1, wherein the first listening interval is longer than the second listening interval.

5-18. (canceled)

19. A machine-to-machine(M2M) device for receiving a paging message at an idle mode in a wireless access system, the M2M device comprising:
a radio frequency unit for transceiving a radio frequency (RF) signal to and from the outside; and
a processor connected with the radio frequency unit,
wherein the processor is configured to receive information including a first and a second paging offsets from a base station(BS), and to receive a paging message during a first listening interval according to the first paging offset, and to receive the paging message during a second listening interval according to the second paging offset when the reception of the paging message during the first listening interval is failed, and
wherein the second paging offset is indicated in a deregistration response (DREG-RSP) message.

20. The M2M device of claim 19, wherein the paging message includes information for performing network entry to the base station.

21. The M2M device of claim 19, wherein the processor is further configured to perform network entry with the BS, when the reception of the paging message is succeed.

22. The M2M device of claim 19, wherein the first listening interval is longer than the second listening interval.

23-27. (canceled)
